(19) United States
(12) Patent Application Publication
(10) Pub. No.: US 2026/0225300 A1
(43) Pub. Date: Aug. 6, 2026

(54) SOYBEAN OKARA-BASED BIODEGRADABLE PLASTICS

(71) Applicant: Zayed University, Dubai (AE)

(72) Inventors: Imane Belyamani, Abu Dhabi (AE); Khalid Abdalla Mohamed Askar, Abu Dhabi (AE)

(73) Assignee: Zayed University, Dubai (AE)

(21) Appl. No.: 19/045,613

(22) Filed: Feb. 5, 2025

(51) Int. Cl. B29C 48/00; B29K 67/00; B29K 105/00; B29K 401/00

(52) U.S. Cl. CPC B29C 48/022; B29K 2067/06; B29K 2105/0038; B29K 2401/00; B29K 2995/006; B29K 2995/0077

(57) ABSTRACT

A method includes receiving, by an extruder, okara. The method includes receiving, by the extruder, a biodegradable polyester. The method includes receiving, by the extruder, plasticizer. The method includes receiving, by the extruder, a binding agent. The method includes generating, by the extruder, a composite material.

### BACKGROUND

The growing challenge of global plastic waste is fueling the demand for sustainable alternatives. One promising solution is to use biodegradable plastics derived from renewable resources such as plant-based materials or agricultural byproducts. Soy pulp (okara) is an industrial solid waste and can be used as a valuable and eco-friendly material source for a more sustainable and circular economy.

However, there is currently no efficient, economical and productive process that allows eco-friendly biodegradable plastics to be generated from soybean by-products.

### BRIEF DESCRIPTION OF DRAWINGS

FIG. 1 is a diagram of an example SEM image of raw okara;

FIG. 2 is a schematic example diagram of fabricating okara biocomposites;

FIGS. 3 to 5 are diagrams of example tables showing typical formulations and processing parameters;

FIG. 6 is a diagram of an example table presenting thermal characteristics;

FIGS. 7A and 7B are diagrams of example FTIR spectra graphs;

FIG. 8 is a diagram of an example stress-strain curves;

FIG. 9 is a diagram of an example table showing mechanical characteristics;

FIG. 10 is a diagram of an example SEM image of fractured surfaces; and

FIGS. 11A, 11B and 11C are diagrams of examples showing the water sensitivity of biocomposites.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein are for fabricating soybean okara-based biocomposites (e.g., biodegradable plastics) using melt-processing and injection molding processes. In embodiments, various formulations of soybean okara-based biocomposites may be fabricated. The different concentrations of biodegradable polyester, plasticizing and binding agents are added to facilitate the okara's processability and improve the biocomposites' properties.

In embodiments, various formulations are evaluated by adding different concentrations of glycerol, polybutylene succinate (PBS) and 2 weight percentage (wt. %) lemongrass essential oil (LGO) to facilitate the okara's processability and also to improve the biocomposites'properties. In embodiments, the biocomposites are further described by structural, morphological and thermal analyses, mechanical testing and water absorption measurements.

In embodiments, biodegradable polyester describes a class of synthetic or natural polymers with ester functional groups in their main chain that, when hydrolyzed under particular environmental conditions or broken down by microorganisms, enzymes or other processes, can produce non-toxic byproducts like carbon dioxide, water, and biomass. In embodiments, “plasticizing agents,” also known as plasticizers, describe chemical substances added to materials to impart workability, flexibility, or stretchability. In embodiments, “binding agents” refers to additives that improve the adherence and compatibility of diverse components in a polymer blend, resulting in a homogeneous and cohesive structure.

In embodiments, biodegradable polyesters can be Polybutylene Succinate (PBS), Polyhydroxyalkanoate (PHA), Poly(3-hydroxybutyrate-co-3-hydroxyvalerate) (PHBV), Polylactic acid (PLA) and Polybutylene Adipate Terephthalate (PBAT). In embodiments, the binding agent can be lemongrass, clove, eucalyptus essential oils, and soybean oil. The plasticizing agents can be glycerol, sorbitol, ethylene glycol, and propylene glycol. In embodiments, various percentages of these additives can be used to tune the mechanical properties of final products.

In embodiments, various biomasses (agricultural wastes) can be processed using the same methodology as utilized in this invention. These include soybean okara, soybean hull, wheat bran, brewer's spent grain, oilseed meals, peanut meal and algae residue. Note that various percentages of biomasses can be processed depending on the protein contents in their composition.

In embodiments, biocomposites with different formulations containing a biodegradable polyester—such as polybutylene succinate (PBS), a plasticizer—such as glycerol, and a binding agent such as—lemongrass oil (LGO) are fabricated.

For example, PBS polymer (20-62 wt. %) is used as an additive to improve the processability and properties of okara-based biocomposites to broaden their applications. In embodiments, glycerol is added with varying concentrations (0-20 wt. %) to facilitate the processing and workability of okara. In embodiments, a plasticizer can weaken or break the intermolecular interactions in polymers, thereby increasing the free volume, segmental mobility, and overall flexibility of polymer-based materials. In embodiments, 0-2 wt. % lemongrass oil (LGO) is added to evaluate its effect on biocomposites'performance. In embodiments, protein is a major constituent of okara and is present in a quantity of 20-35% (dry matter), depending on the source and processing conditions.

In embodiments, the percentage of protein in raw okara is required because the appropriate protein content is expected to govern the okara's extrusion. In embodiments, during extrusion, the combination of temperature and shear force alters the soy proteins' conformational and molecular structures. In embodiments, the proteins are denatured, dissociated, and unraveled, allowing the alignment of the denatured protein molecules in the direction of the flow. Additionally, the interactions between the denatured protein and polysaccharides provide better flowability, suitable for okara extrusion and injection molding.

In embodiments, the described biocomposites exhibit tensile strength ranging from 1 to 7 MPa and impact toughness from 1 to 3.5 kJ/m². The described biocomposites have potential applications in sectors requiring moderate tensile strength/yielding in dry environments. Potential applications may include decorating materials, the packaging industry, indoor furniture, and transportation sectors.

In embodiments, the biocomposites' fabrication techniques can include industrial-scaled twin-screw extruders and injection molding machines to produce functional technical objects. In embodiments, such fabrication techniques are well suited for commercially scaling biocomposites for manufacturing. Moreover, the described biocomposite filaments can be used as a feedstock for three-dimensional (3D) printing technology, such as the fused deposition modelling (FDM) technique. This suggests that other biodegradable biocomposite feedstocks (filaments) fabricated using the methodology in this study are compatible with FDM technology.

In embodiments, a high-resolution scanning electron microscope (SEM) is used to analyze the raw okara and biocomposites. Before the SEM analysis, a thin gold coating is deposited on the samples using a sputter coater to avoid a charging effect.

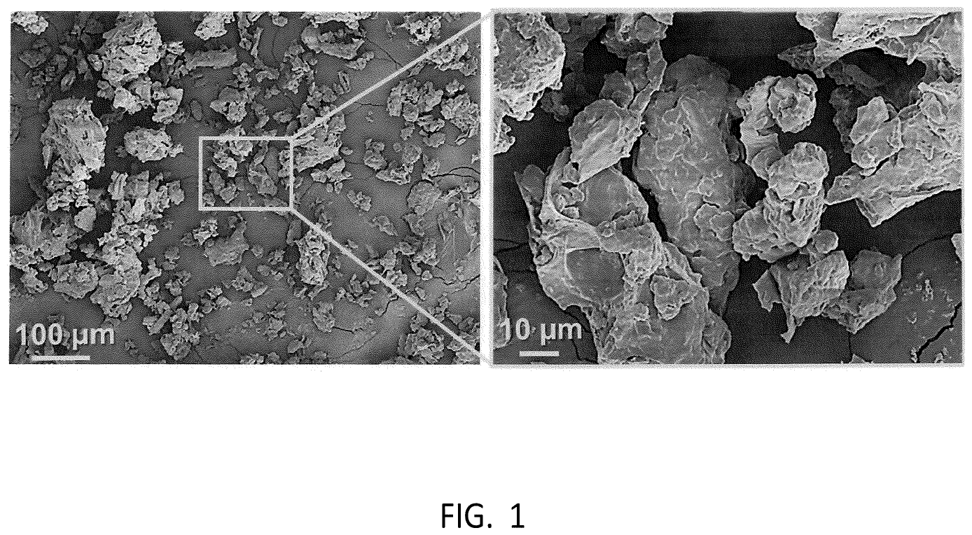

In embodiments, SEM is used to analyze the morphology of raw okara powder, as shown in FIG. 1. In embodiments, the surface of okara is found to be uneven and rough, featuring superimposed layers with pronounced gullies (as shown in FIG. 1) due to having high protein and fiber content in both bound and free forms that aggregate into clumps.

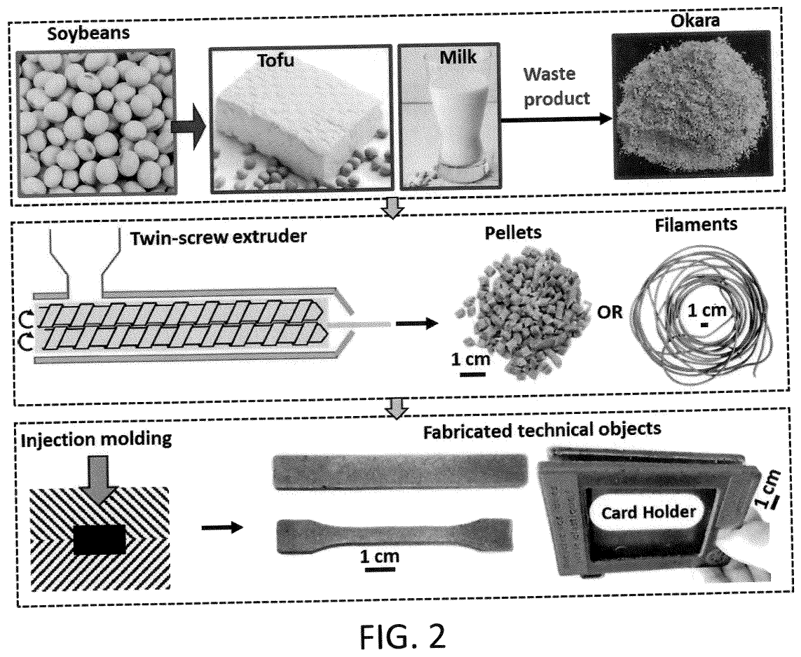

FIG. 2 describes an example of a schematic illustration of the research methodology used in this study to fabricate the biocomposites. As shown in FIG. 2, the 1st row shows the industrial waste generation (i.e., also known as soy pulp and also called okara) from soy tofu/milk production companies. As shown in FIG. 2, the 2nd row shows the utilization of okara to make pellets or filaments through the melt-extrusion process with the aid of some plasticizers/additives. As shown in FIG. 2, the 3rd row shows the fabrication of technical objects/structures through the injection molding process using pellets/filaments.

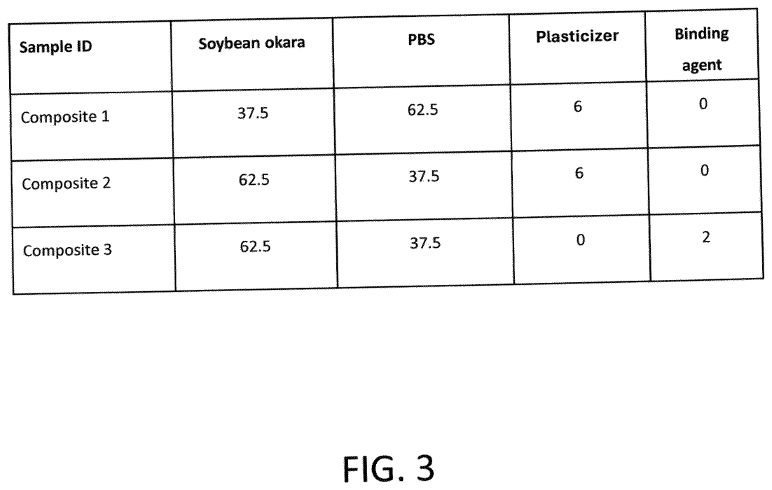

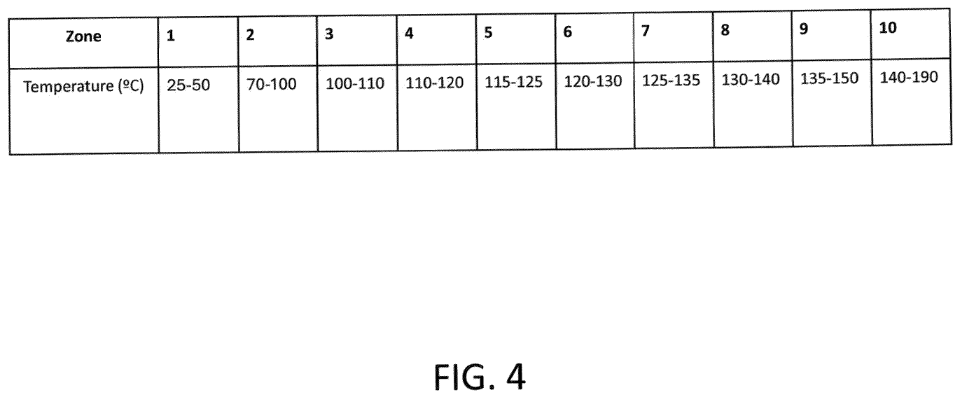

In embodiments, various formulations of okara, PBS, glycerol, and LGO are prepared and are shown in the table described in FIG. 3. In embodiments, each formulation is mechanically mixed and used as a feedstock for melt processing in a twin-screw extruder with ten heating zones. In embodiments, the temperature profile kept in the zones of the twin-screw extruder is detailed in the table as described in FIG. 4. The advantage of using twin-screw extrusion is that many operations can be combined simultaneously: melting, mixing, kneading, stretching, and conveying.

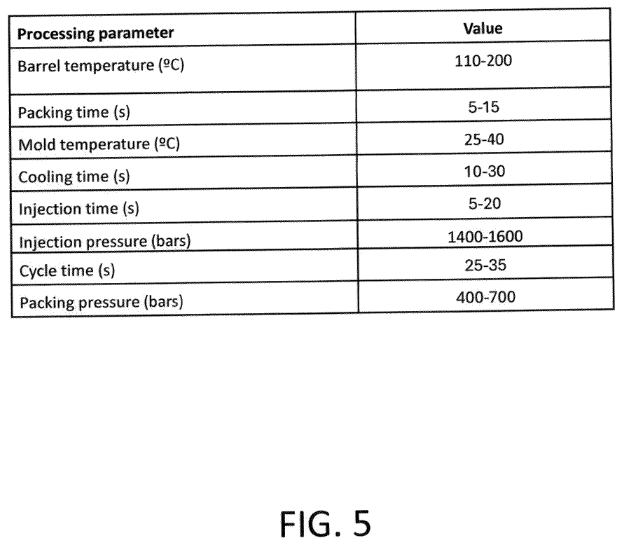

In embodiments, extrusion can result in a highly efficient manufacturing method with commercial potential for large-scale production of okara-based materials due to the low moisture levels, high temperatures, and short time involved. After the extrusion step, the extrudates are injection-molded using an injection molding machine to achieve the desired sample shapes (see FIG. 2). The parameters used for injection molding are listed in the table described in FIG. 5.

In embodiments, the specified ranges of processing parameters, including temperatures and pressures, as illustrated in FIGS. 4 and 5. These ranges define the conditions requisite for the fabrication of the diverse biocomposite materials disclosed herein. The processing parameters vary depending on the specific compositions and formulations employed, which exhibit distinct melting points and melt viscosities. The variations in these parameters are intended to accommodate the unique properties of each composition, ensuring optimal performance and manufacturability.

In embodiments, differential scanning calorimetry (DSC) is used to analyze the thermal characteristics of raw materials (as a reference), which is essential for probing the processing conditions (i-e., melt processing). In embodiments, the fabricated biocomposites are also analyzed. In embodiments, all the samples are heated in aluminum crucibles at a rate of 10° C./min in a nitrogen atmosphere. Thermogravimetric analysis (TGA) is used to evaluate the thermal stability of raw materials and biocomposites. All the samples are heated in alumina crucibles at a rate of 10° C./min in a nitrogen atmosphere. In embodiments, the nitrogen flow rate in both thermal techniques is kept constant (20 ml/min) throughout the analysis.

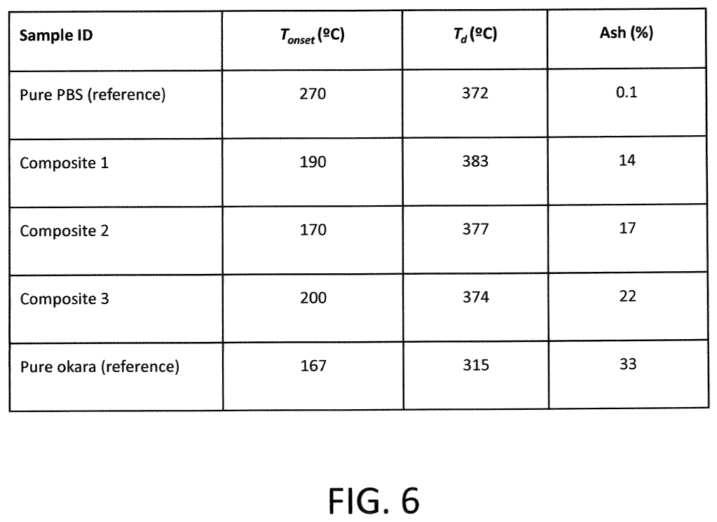

In embodiments, the thermal stability of raw okara, PBS and biocomposites in terms of thermal degradation temperature (T_{d}) and initial degradation temperature (Tₒₙₛₑₜ) are summarized in the table, shown in FIG. 6. Note that these values are deduced from TGA/DSC analyses. In embodiments, the biocomposites show relatively better thermal stability than pure PBS or okara, as depicted by T_{d} values in the table shown in FIG. 6. In embodiments, the char residue percentages (ash) at 700° C. decrease when the polymer percentage is added/increased into biocomposites. This may be due to the formation of a complex structure between okara and PBS that increases the specific surface area of the okara in the biocomposite, resulting in higher material loss.

In embodiments, Fourier transform infrared (FTIR) analysis is performed on raw materials (as reference) and fabricated biocomposites to study the chemical changes that might occur due to the different potential chemical interactions between okara components and added additives after processing. Furthermore, analysis is performed on raw materials and fabricated biocomposites. In embodiments, the attenuated total reflectance (ATR) mode is used for the analysis in the range between 400 and 4000 cm⁻¹ with 4 cm⁻¹ resolution and 64 scans.

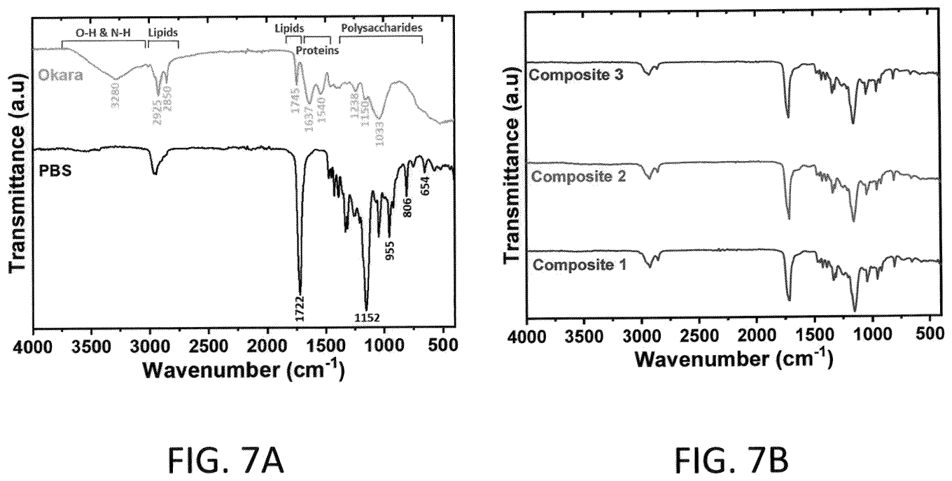

In embodiments, the FTIR spectra of raw materials (okara and PBS) and biocomposites are presented in FIGS. 7A and 7B, respectively. In general, biocomposites show the mixed bands of okara and PBS. A closer look at the biocomposites'spectra (FIG. 7B) reveals some changes in the intensities of bands, overlapping of individual bands of okara and PBS along with the appearance/disappearance of a few bands based on various formulations. These observations indicate an interfacial bonding (interaction) between okara and PBS without phase separation, which is important for improving mechanical properties.

In embodiments, the mechanical performance of fabricated biocomposites is evaluated by performing tensile and Charpy impact tests.

In embodiments, the quasi-static uniaxial tensile tests are performed on all the biocomposites using a universal testing machine (UTM). In embodiments, the dogbone-shaped specimens with a gauge section area of 5×2 mm² are tested at a crosshead speed of 2.5 mm/min. Mechanical characteristics such as Young's modulus, tensile strength, elongation at break, and toughness are calculated using the stress-strain curves. In embodiments, the elastic modulus is calculated in the elastic region (around 0.1% yield strain) and toughness is calculated by integrating the area under the stress-strain curve. In embodiment, Charpy impact tests are performed on all the biocomposites using a pendulum impact tester. ISO 179 standard is followed for the tests. In embodiments, the notched bar-shaped specimens (2 mm notch) with dimensions of 80×10×4 mm³ are tested using a hammer with an energy of 0.5 J.

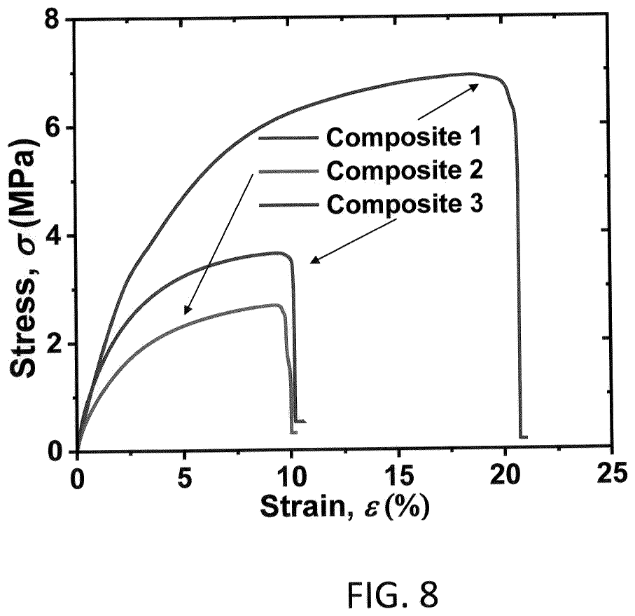

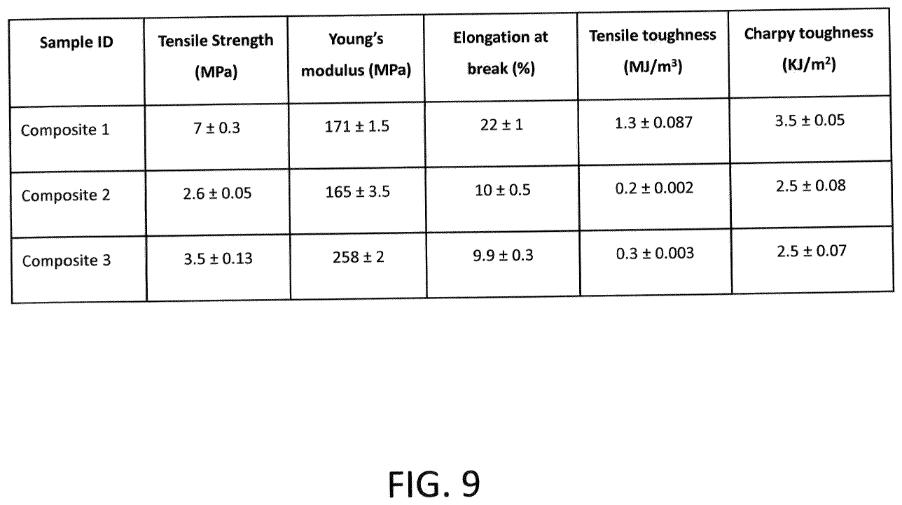

In embodiments, the typical stress-strain responses of biocomposites evaluated under uniaxial tensile tests are presented in FIG. 8. The mechanical characteristics deduced from stress-strain curves (FIG. 8) after tensile tests are listed in the table, as shown in FIG. 9. Note that the last column of the table (FIG. 9) presents the toughness values obtained from Charpy impact tests.

In the embodiments, FIGS. 8 and 9 show the tensile results of typical fabricated biocomposites, indicating that the polymer % is the key factor controlling the strength and ductility of the biocomposites. That's why Composite 1 (the sample with the highest polymer content of ~62%) showed the highest tensile strength (~7 MPa), Young's modulus (~171 MPa), and ductility (~22%) compared to other formulations tested in this disclosure.

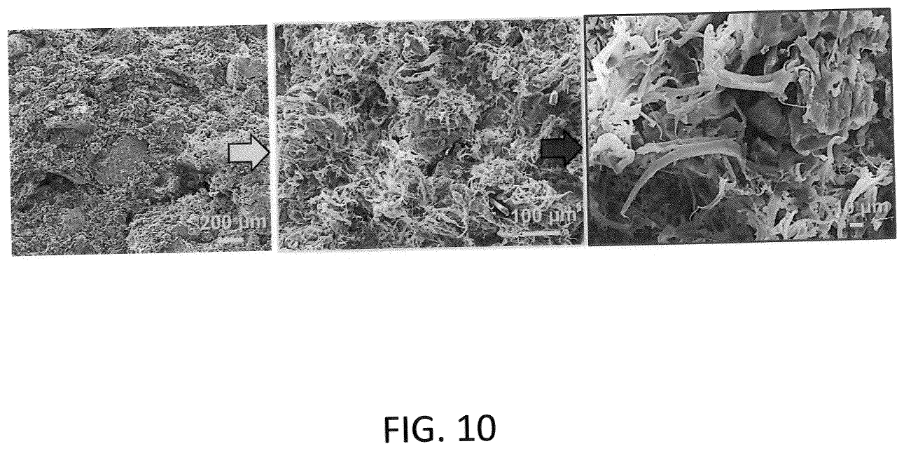

In the embodiments, FIG. 10 shows the typical SEM images of fractured surfaces of the typical sample (Composite 1) at different magnifications. Generally, a higher wt. % of polymer makes the dense and longer network of fibrils around okara, which avoids the easy breakage of the samples. That's why less porosity/voids in Composite 1 are observed, as evidenced by SEM images captured at low magnification (FIG. 10) compared to other formulations.

In the embodiments, Composite 3 (containing LGO) showed improved tensile strength (~35%) and modulus (~56%) than Composite 2 (without LGO). This may be due to the role of LGO as a compatibilizer that can minimize the voids and improve the densification of biocomposite.

In embodiments, Composite 1 also showed improved impact toughness (~40%) than other formulations (as shown in the table in FIG. 9), as expected due to higher polymer %. Surprisingly, Composite 2 and Composite 3 show similar impact toughness (~2.5 KJ/m²), indicating no significant effect of glycerol or LGO on the impact toughness compared to that observed in tensile tests. They may be due to the high strain rate, notch effect and dynamic loading conditions that make the biocomposites more brittle and less sensitive. Note that the impact toughness of the fabricated composites is comparable to that of certain synthetic thermoplastics (e.g., PS, SAN, PMMA) and even exceeds that of some thermosets.

In embodiments, the water activity (also called water sensitivity) of fabricated biocomposites is evaluated in terms of water absorption tests. The analyses are conducted at room temperature using the ASTM D570 standard. The pre-weighted samples are submerged in deionized (DI) water within enclosed glass containers.

In embodiments, the water activity determines how a material interacts with moisture. Water activity impacts the material's structural integrity, strength, and durability. This helps in predicting the material's performance in humid or wet conditions, ensuring its long-term reliability.

In a non-limiting example, water absorption tests are continued for 60 days, and the weight difference of each sample is monitored periodically using a precise weight balance. In embodiments, the DI water is replaced periodically with fresh DI water. Before weighing each time (after a specific time interval), the samples are removed from the DI water and wiped gently using lint-free tissues. Furthermore, the change in thickness is also monitored to analyze the biocomposites' dimensional stability (i-e., swelling or leaching behavior).

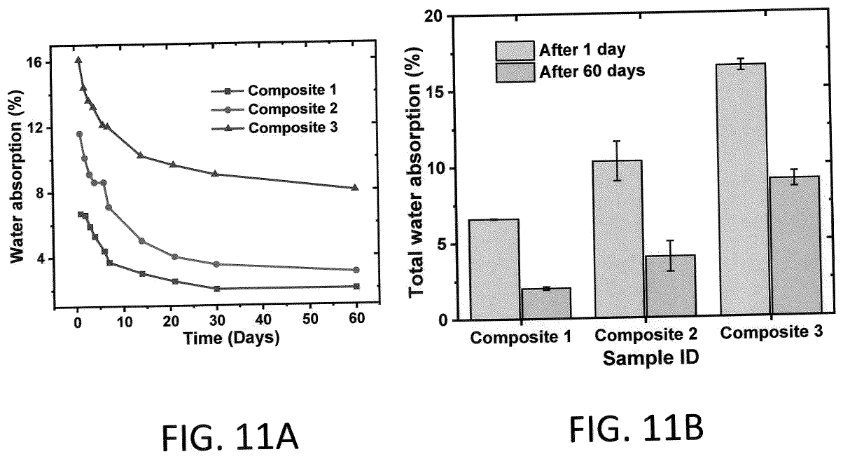

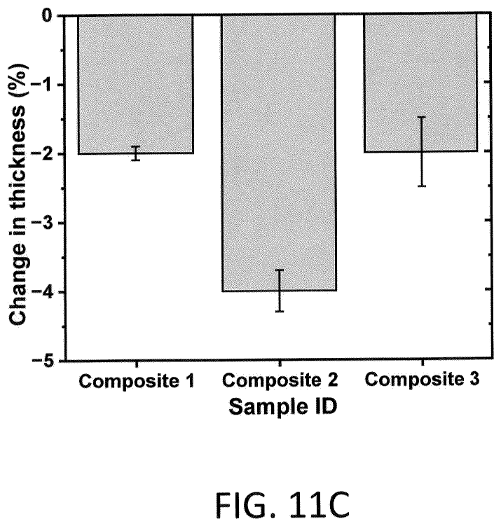

FIG. 11A describes the water sensitivity of fabricated biocomposites and shows water absorption measurements after specific intervals. FIG. 11B shows total water absorption (TWA) of biocomposites after 1 day and 60 days of water absorption. FIG. 11C shows the change in thickness (%) of the samples after immersing them in water for 60 days.

In embodiments, FIG. 11A shows that the biocomposite with higher concentrations of okara showed more water absorption due to the inherent nature of okara, as expected. In general, the water absorption rate became lower and almost constant after 30 days for all the formulations. Surprisingly, Composite 2 showed less water absorption than Composite 1. Note that both formulations have similar percentages of polymer and okara with the only difference of having additional glycerol or LGO component (for example, see FIG. 3). It is attributed to the high solubility of glycerol, which caused it to leach out from the biocomposite and compensate for the water absorption.

In embodiments, FIG. 11B describes a graph that compares the total water absorption (TWA) of biocomposites evaluated after 1 and 60 days, respectively. As shown in FIG. 11B, all the biocomposites showed a reduction in TWA after 60 days compared to the results obtained after 1 day. This is attributed to the slight leaching of okara in water for a prolonged period of time, which also caused a reduction in the thickness of the samples instead of swelling, as described in FIG. 11C. Although the biocomposites with higher concentrations of either okara or glycerol showed relatively greater thickness reduction, all biocomposites exhibited a uniform reduction in thickness without any additional defects, such as voids or bubbles.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by an extruder, okara;
receiving, by the extruder, a biodegradable polyester;
receiving, by the extruder, a plasticizer;
receiving, by the extruder, a binding agent; and
generating, by the extruder, a composite material.

2. The method of claim 1, wherein the generating the composite material is done at a particular temperature.

3. The method of claim 1, wherein the composite material is configured with a tensile strength that is greater than 2.55 MPa.

4. The method of claim 1, wherein the binding agent is one of lemongrass, clove, eucalyptus essential oils, or soybean oil.

5. The method of claim 1, wherein the plasticizer is one of glycerol, sorbitol, ethylene glycol, or propylene glycol.

6. The method of claim 1, wherein the biodegradable polyester is one of Polybutylene Succinate (PBS), Polyhydroxyalkanoate (PHA), Poly(3-hydroxybutyrate-co-3-hydroxyvalerate) (PHBV), Polylactic acid (PLA), or Polybutylene Adipate Terephthalate (PBAT).

7. A composite material, comprising:
okara;
a biodegradable polyester;
a plasticizer; and
a binding agent, wherein the composite material is manufactured by processing the okara, the biodegradable polyester, the plasticizer, and the binding agent through an extruder.

8. The composite material of claim 7, wherein the composite material is generated at a particular temperature.

9. The composite material of claim 7, wherein the composite material is configured with a tensile strength that is greater than 2.55 MPa.

10. The composite material of claim 7, wherein the binding agent is one of lemongrass, clove, eucalyptus essential oils, or soybean oil.

11. The composite material of claim 7, wherein the plasticizer is one of glycerol, sorbitol, ethylene glycol, or propylene glycol.

12. The composite material of claim 7, wherein the biodegradable polyester is one of Polybutylene Succinate (PBS), Polyhydroxyalkanoate (PHA), Poly(3-hydroxybutyrate-co-3-hydroxyvalerate) (PHBV), Polylactic acid (PLA), or Polybutylene Adipate Terephthalate (PBAT).
